(19) United States
(12) Patent Application Publication
(10) Pub. No.: US 2017/0316327 A1
(43) Pub. Date: Nov. 2, 2017

(54) ONTOLOGY REASONING METHOD AND APPARATUS

(71) Applicant: FOUNDATION OF SOONGSIL UNIVERSITY INDUSTRY COOPERATION, Seoul (KR)

(72) Inventors: Young Tack PARK, Seoul (KR); Hyun Kyu PARK, Seoul (KR); Wan Gon LEE, Seoul (KR); Batselem Jagvaral, Seoul (KR)

(21) Appl. No.: 15/281,959

(22) Filed: Sep. 30, 2016

(30) Foreign Application Priority Data
Apr. 29, 2016 (KR) 10-2016-0053008

(51) Int. Cl. G06N 5/04; H04L 29/06; G06N 7/00

(52) U.S. Cl. CPC G06N 5/046; G06N 7/005; H04L 65/4076

(57) ABSTRACT

Ontology reasoning method and apparatus are disclosed. The ontology reasoning method comprises (a) broadcasting a schema triple to nodes; (b) partitioning triples other than the schema triple and distributing the partitioned triples to the nodes; and (c) reasoning at least one of the schema triple or the triples according to a reasoning rule and then renewing a confidence value of the reasoned triple.

### TECHNICAL FIELD

The present disclosure relates to a confidence value based ontology reasoning method and apparatus.

### BACKGROUND ART

Recently, various intelligent systems, which provide meaningful information by using big data and an ontology, have been studied. The intelligent systems solve a problem over data including erroneous information by using a method of providing a value, for showing confidence degree of data, based on a machine learning algorithm and verification of a curator. A conventional study for performing a confidence value based ontology reasoning uses a fuzzy theory for calculating the confidence value according to RDFS, OWL Horst rule. The conventional study defines a semantic reasoning rule for processing OWL Horst expressed by a description logic based logical formula. However, the conventional study does not provide a solution for solving a problem about calculation and selection of a confidence value about same data reasoned with duplication. Since data reasoned with duplication according to the same reasoning rule and data reasoned with duplication according to different rules occur in the RDFS, OWL Horst reasoning rule, the confidence values of the data reasoned with duplication should be selected. Accordingly, it is necessarily required to calculate the confidence value. Additionally, many conventional studies such as WebPIE apply a map-reduce framework of a Hadoop and a distribution technology to scalable ontology reasoning. However, the conventional studies reason scalable triple without considering uncertainty of a knowledge-based system, and do not provide a solution for solving a problem about calculation and selection of the confidence values about same data reasoned with duplication.

### SUMMARY

Accordingly, the invention is provided to substantially obviate one or more problems due to limitations and disadvantages of the related art. One embodiment of the invention provides a confidence value based scalable ontology reasoning system and method of reasoning efficiently scalable ontology based on a confidence value and processing a confidence value of data reasoned with duplication.

In one aspect, the invention provides an ontology reasoning method comprising: (a) broadcasting a schema triple to nodes; (b) partitioning triples other than the schema triple and distributing the partitioned triples to the nodes; and (c) reasoning at least one of the schema triple or the triples according to a reasoning rule and then renewing a confidence value of the reasoned triple.

In the steps of (a) and (b), only triple related to a reasoning rule to be used of the reasoning rule is selectively broadcasted and partitioned.

In the step of (a), a join operation is performed about the schema triple when the schema triple corresponds to a multiple join rule, and new schema triple obtained by the join operation is broadcasted to each of the nodes.

The triples other than the schema triple include an instance triple and a type triple.

Here, in the step of (b), the instance triple and the type triple is again partitioned by using a hash partitioning when the reasoning rule corresponds to a multiple join rule, and an instance triple and an type triple for reasoning according to a specific multiple join rule are partitioned to the same node.

In the step of (b), a RDD set is generated except a property when the reasoning rule corresponds to a transitivity rule, a new reasoning rule is generated through a join operation, an instance triple and a type triple are partitioned based on the generated new reasoning rule by using a hash partitioning and the partitioned triples are distributed to each of the nodes.

In the step of (c), confidence values of a triple reasoned with duplication according to the same reasoning rule are renewed to maximum confidence value of the confidence values when the confidence values differ.

In the step of (c), confidence values of a triple reasoned with duplication according to different reasoning rules are renewed to a confidence value calculated through pMax about the reasoned triple when the confidence values differ.

The triple is stored in a property table, wherein every data entering into a relation with a subject of the triple through a specific property is stored in each of rows of the property table.

In another aspect, the invention provides an ontology reasoning apparatus for reasoning efficiently scalable ontology based on a confidence value and processing a confidence value of data reasoned with duplication.

In still another aspect, the invention provides an ontology reasoning apparatus comprising: a data distribution unit configured to broadcast a schema triple to nodes, partition triples other than the schema triple and distribute the partitioned triples to the nodes; a reasoning unit configured to reason at least one of the schema triple or the triples according to a reasoning rule; and a renewing unit configured to renew a confidence value of the reasoned triple.

The renewing unit renews confidence values of a triple reasoned with duplication through a maximum confidence value of the confidence values or a pMax operation.

The invention provides an ontology reasoning method and apparatus, thereby reasoning efficiently scalable ontology based on a confidence value and processing a confidence value of data reasoned with duplication.

### BRIEF DESCRIPTION OF DRAWINGS

Example embodiments of the present invention will become more apparent by describing in detail example embodiments of the present invention with reference to the accompanying drawings, in which:

FIG. 1 is a flowchart illustrating an ontology reasoning method according to one embodiment of the invention;

FIG. 2 is a view illustrating an example of an OWL Horst reasoning rule;

FIG. 3 is a view illustrating an example of a pseudo code depending on a reasoning method of a single join operation according to one embodiment of the invention;

FIG. 4 is a view illustrating an example of a pseudo code according to a reasoning method of rules using multiple joins;

FIG. 5 is a view illustrating an order of a reasoning rule according to one embodiment of the invention;

FIG. 6 is a view illustrating an example of a property table according to one embodiment of the invention;

FIG. 7 is a view illustrating a method of renewing a confidence value of a triple reasoned with duplication depending on the same reasoning rule according to one embodiment of the invention;

FIG. 8 is a view illustrating a method of renewing a confidence value of a triple reasoned with duplication depending on different reasoning rules according to one embodiment of the invention; and

FIG. 9 is a block diagram illustrating schematically an ontology reasoning apparatus according to one embodiment of the invention.

### DETAILED DESCRIPTION

In the present specification, an expression used in the singular encompasses the expression of the plural, unless it has a clearly different meaning in the context. In the present specification, terms such as “comprising” or “including,” etc., should not be interpreted as meaning that all of the elements or operations are necessarily included. That is, some of the elements or operations may not be included, while other additional elements or operations may be further included. Also, terms such as “unit,” “module,” etc., as used in the present specification may refer to a part for processing at least one function or action and may be implemented as hardware, software, or a combination of hardware and software.

Hereinafter, various embodiments of the invention will be described in detail with reference to accompanying drawings.

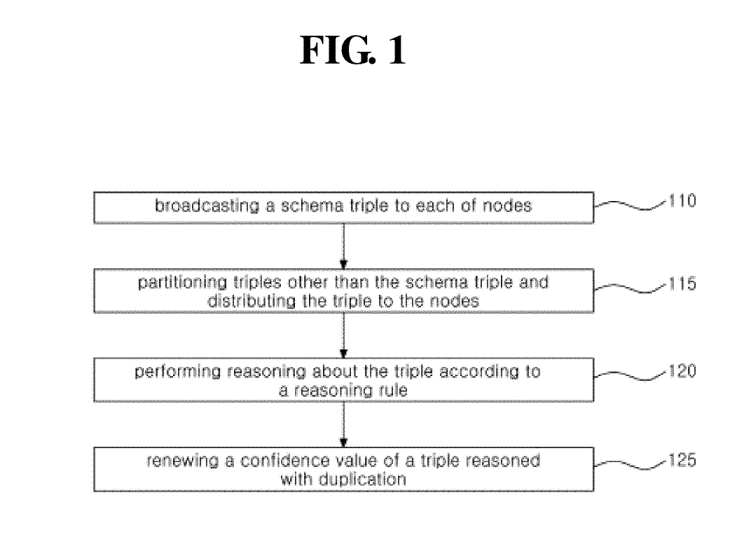

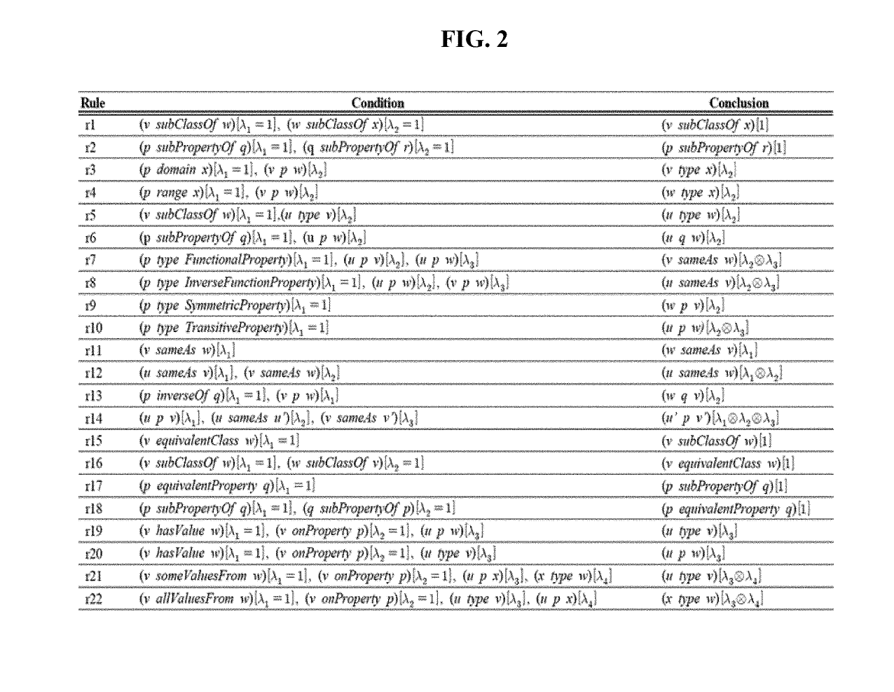

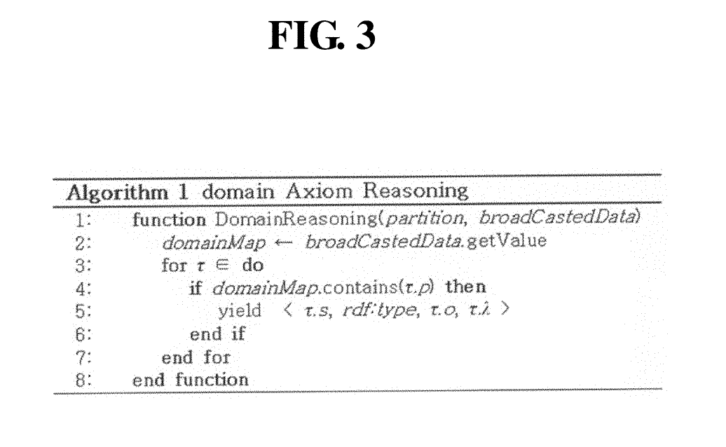

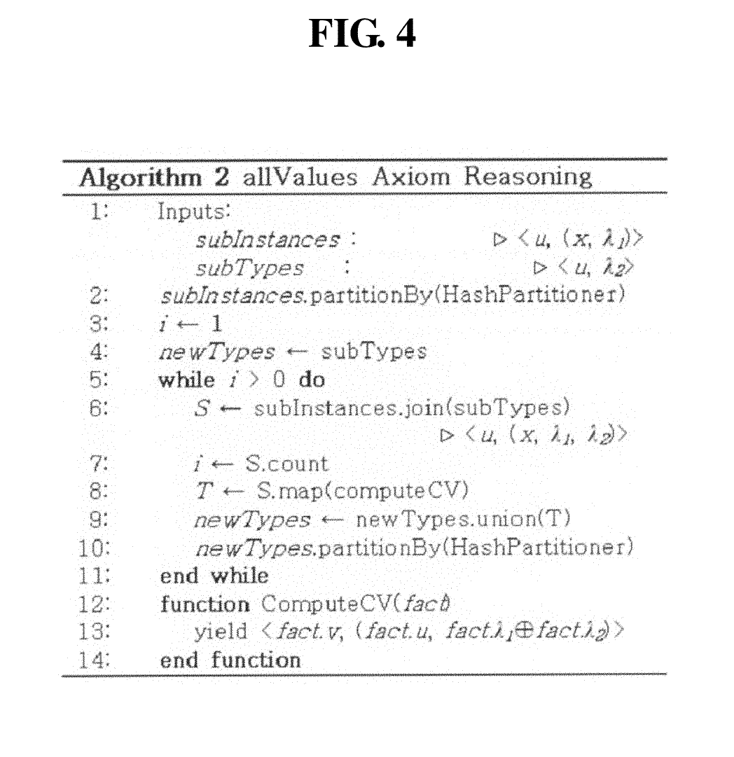

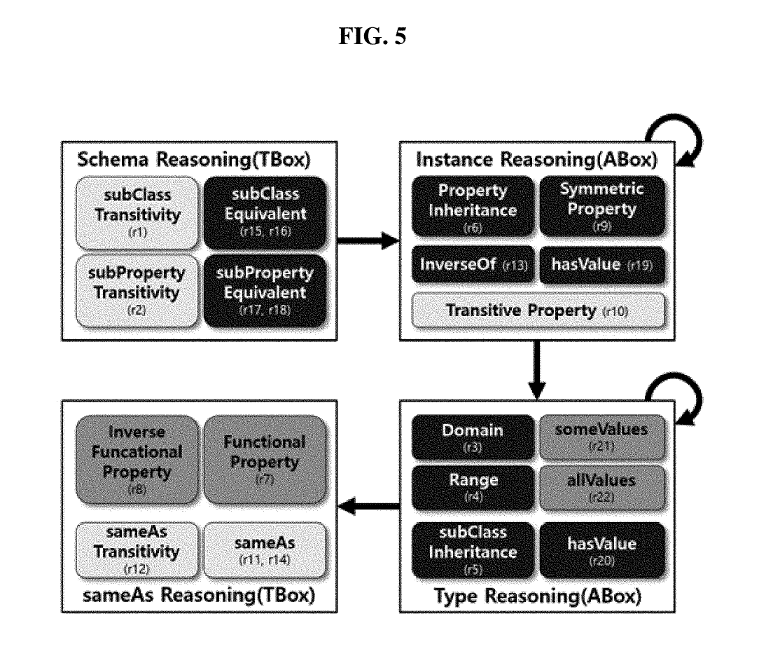

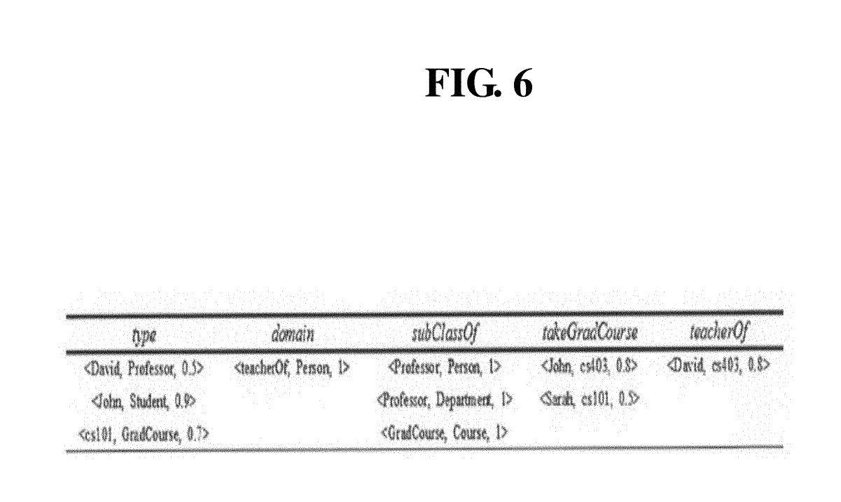

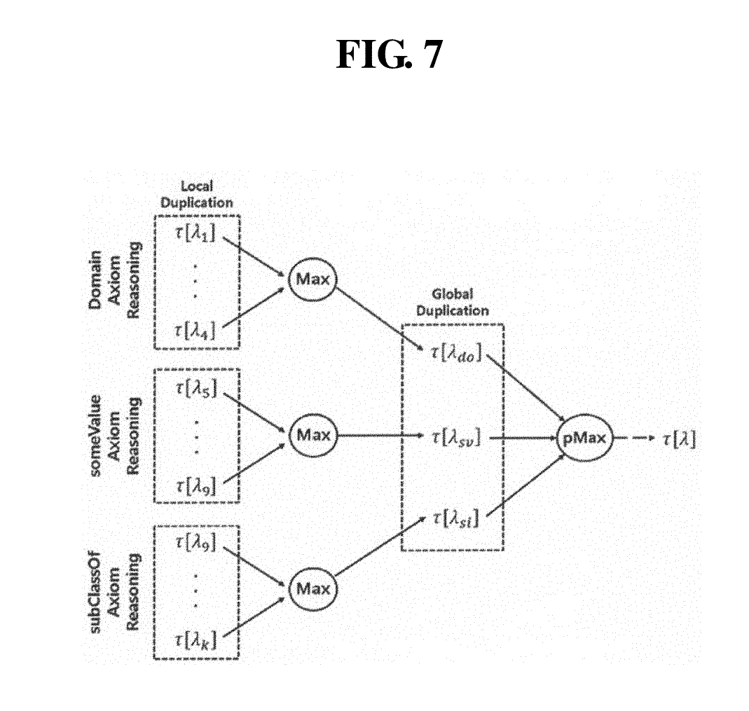

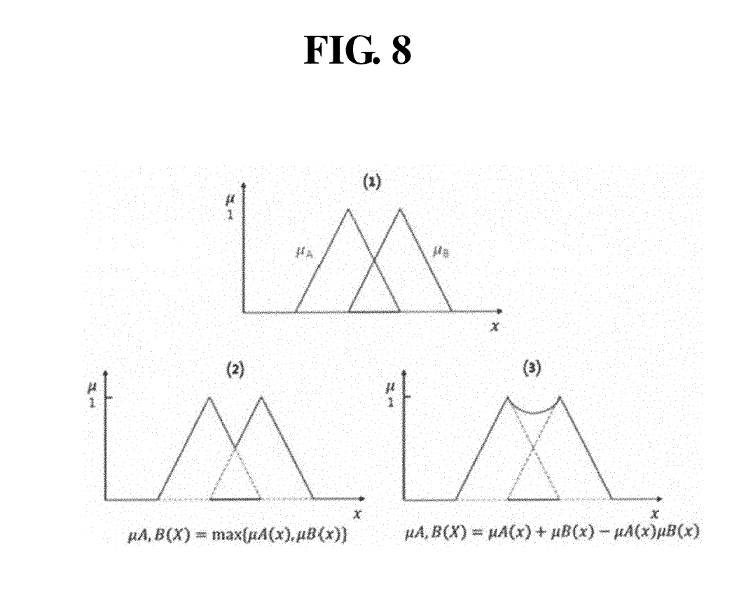

FIG. 1 is a flowchart illustrating an ontology reasoning method according to one embodiment of the invention, and FIG. 2 is a view illustrating an example of an OWL Horst reasoning rule. FIG. 3 is a view illustrating an example of a pseudo code depending on a reasoning method of a single join operation according to one embodiment of the invention, and FIG. 4 is a view illustrating an example of a pseudo code according to a reasoning method of rules using multiple joins. FIG. 5 is a view illustrating an order of a reasoning rule according to one embodiment of the invention, and FIG. 6 is a view illustrating an example of a property table according to one embodiment of the invention. FIG. 7 is a view illustrating a method of renewing a confidence value of a triple reasoned with duplication depending on the same reasoning rule according to one embodiment of the invention, and FIG. 8 is a view illustrating a method of renewing a confidence value of a triple reasoned with duplication depending on different reasoning rules according to one embodiment of the invention.

In a step of 110, an ontology reasoning apparatus 900 broadcasts a schema triple of ontology data so that the schema triple is stored in a memory of each of nodes.

In a step of 115, the ontology reasoning apparatus 900 partitions triples other than the schema triple and distributes the partitioned triples to respective nodes.

Particularly, the ontology reasoning apparatus 900 may broadcast the schema triple of the ontology data after duplicating the schema data so that the schema triple is stored in the memory of each of the nodes. The ontology reasoning apparatus 900 may partition the triples other than the schema triple of the ontology data and distribute the partitioned triples to the nodes.

Data amount of the schema triple of the ontology data is generally smaller than that of an instance triple or a type triple. The schema triple can be stored in the memory of respective nodes.

Furthermore, the schema triple is frequently used in a reasoning process.

Accordingly, to prevent data shuffling or network shuffling, the ontology reasoning apparatus 900 may broadcast the smallest amount of the schema data of the ontology data after duplicating the schema data so that the schema triple is stored in the memory of each of the nodes, partition the triples other than the schema triple and distribute the partitioned triples to each of the nodes.

The ontology reasoning apparatus 900 may store or distribute only a part of the schema triple and the triples other than the schema triple needed for reasoning according to a reasoning rule in or to the nodes.

FIG. 2 shows an example of an OWL Horst reasoning rule. As shown in FIG. 2, a part of the OWL Horst reasoning rule requires a plurality of triples, so as to perform reasoning.

In this case, a problem exists in that a reasoning performance is deteriorated because many parts of data should be searched and processed.

Accordingly, the ontology reasoning apparatus 900 of the present embodiment may classify the reasoning rules into a single join rule, a multiple join rule and a transitivity rule according to a feature of the OWL Horst reasoning rule and then perform a distribution depending on the rules.

In reasoning rules in FIG. 2, r3, r4, r5, r6, r9, r13, r19 and r20 may be classified as the single join rule. The single join rule may perform the reasoning through a single join operation.

In the single join rule, one schema triple and one instance triple are used in a condition.

Accordingly, the ontology reasoning apparatus 900 may broadcast the schema triple corresponding to the single join rule to each of the nodes so that the schema triple is stored in the memory in each of the nodes, partition the instance triple and store the partitioned instance triple in respective nodes.

Subsequently, each of the nodes (partition) may perform the reasoning through the single join operation.

FIG. 3 illustrates a pseudo code about a reasoning using the single join operation.

In reasoning rules in FIG. 2, r21 and r22 rules are classified as the multiple join rule. The multiple join rule requires a join operation of scalable instance data and the type triples.

Accordingly, to reason the multiple join rules, the ontology reasoning apparatus 900 may broadcast schema data related to the multiple join rule so that the schema data is stored in the memory of respective nodes.

In the event that the join operation of the schema triple related to the multiple join rule is needed, a master node may perform a local join and broadcast a joining result in accordance with the local join to respective nodes. The memory of each of the nodes may store the joining result.

For example, referring to r22 of the reasoning rule in FIG. 2, the schema triple (data) includes “(v allValuesFrom w)” and “(v OnProperty p)”. Since amount of the schema data is small, the ontology reasoning apparatus 900 may broadcast a (v p) typed joining result obtained by performing the local join at the master node to the nodes so that the joining result is stored in the memory in each of the nodes.

In the multiple join rules, network shuffling occurs because a process of repetitively reasoning again reasoned triples according to the reasoning rule is needed.

However, the ontology reasoning apparatus 900 may partition again the instance data and the type data by using a hash partitioning before a type reasoning is performed, and distribute the partitioned data so that two data sets exist in the same partition (node). As a result, data shuffling may be prevented and only the reasoned triple may be used at corresponding partition (node) when repetitive reasoning is performed.

Since the hash partitioning is well-known in a distribution processing system, any further description concerning the hash partitioning will be omitted.

FIG. 4 shows an example of a pseudo code about a reasoning method of rules using multiple joins.

r11, r12 and r13 in FIG. 2 are rules related to “sameAs” reasoning. Here, r11 and r13 perform the single join operation, and r12 performs a transitivity rule operation.

The ontology reasoning apparatus 900 may generate a RDD set except samsAs which is property of transitivity rules, and then partition a joining result through the hash partitioning and broadcast the partitioned joining result to respective nodes. Moreover, the ontology reasoning apparatus 900 may swap (u v) to (u w) and partition (u w).

For example, a reasoning rule r12 may generate a RDD set except sameAs which is the property like (u v) and (v w), generate (u w) by performing the join operation and then partition (u w) using the hash partitioning.

In a step of 120, the ontology reasoning apparatus 900 reasons the triple based on the reasoning rule.

An order of the reasoning based on the reasoning rule by the ontology reasoning apparatus 900 is shown in FIG. 5 as following:

Best reasoning performance is generally obtained when reasoning rules not be affected by a result reasoned by other rules are firstly performed. Accordingly, the ontology reasoning apparatus 900 performs firstly a schema reasoning as shown in FIG. 5. Triples reasoned by the schema reasoning are frequently used in rules where instance triples and type triples use in a condition, and thus the schema reasoning is performed first of all.

In the ontology reasoning, data amount of an instance triple and a type triple is comparatively higher than that of schema triple, and thus rules reasoning the instance triple and the type triple have the biggest influence to the reasoning performance.

Rules for an instance reasoning in FIG. 5 reason frequently triples usable in a condition of a type reasoning and require more high throughput. As a result, the instance reasoning may be performed before the type reasoning.

The instance reasoning and the type reasoning are repetitively performed until no new triple is reasoned, and then next step may be progressed.

Every rule related to sameAs Reasoning (TBox) in FIG. 5 may reason triples related to sameAs as a reasoning result. Since other rules do not use the triples in their conditions, they are last performed, and then the reasoning process is completed.

The triples may be stored in a property table as shown in FIG. 6.

The property table stores every value entering into a relation with subjects in respective rows through a specific property. Accordingly, several triples may be stored in one column in the property table, and so advantage of RDF data structure may be obtained.

The triples are stored in the property table as shown in FIG. 6, and thus only data having a property relation needed when the reasoning rule is performed is accessible. Accordingly, unnecessary usage of the memory may reduce.

In a step of 125, the ontology reasoning apparatus 900 renews a confidence value of a new triple.

For example, the ontology reasoning apparatus 900 may renew confidence values of a triple reasoned with duplication to maximum confidence value when the confidence values of the triples reasoned with duplication according to the same reasoning rule differ.

FIG. 7 illustrates a method of renewing a confidence value of a triple reasoned with duplication according to the same reasoning rule.

In one embodiment, the confidence value means confidence of each of the triple data, and may have a range of 0 to 1. A confidence value 0 indicates uncertainty of corresponding triple data, but does not mean negative of the triple data.

Confidence values of the triple reasoned with duplication according to a reasoning rule using the same schema triple or different instance data have disjunction relation, thereby deteriorating confidence.

Accordingly, the ontology reasoning apparatus 900 of the present embodiment may renew the confidence values of the triple reasoned with duplication by using the maximum confidence value of the confidence values.

Additionally, the ontology reasoning apparatus 900 may renew the confidence value by using pMax, in case of the triple reasoned with duplication according to different rules (referring to FIG. 8).

It is necessary to amend the confidence value of the triple reasoned with duplication because different rules require different conditions. Duplicated reasoning in different conditions means the fact that corresponding data frequently generate. This indicates that many evidences about confidence of corresponding data exist.

Accordingly, the ontology reasoning apparatus 900 may calculate the confidence value of the triple reasoned with duplication by different rules through the pMax as shown in FIG. 8, and renew the confidence value of the triple reasoned with duplication.

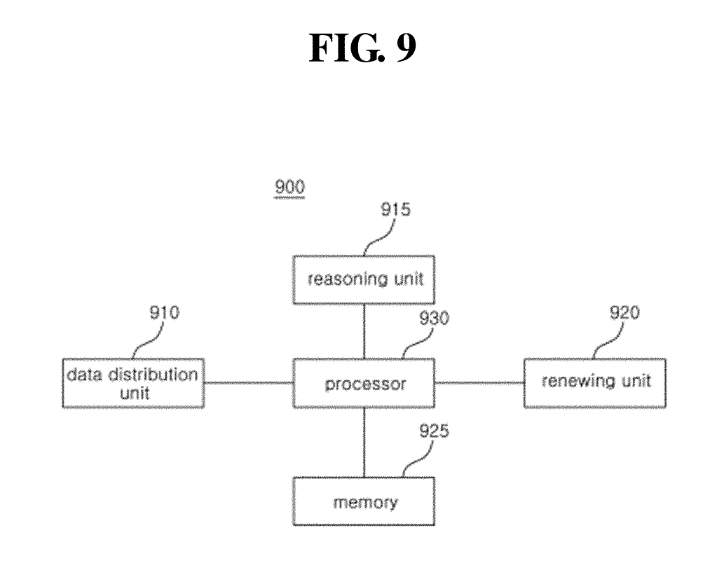

FIG. 9 is a block diagram illustrating schematically an ontology reasoning apparatus according to one embodiment of the invention.

In FIG. 9, the ontology reasoning apparatus 900 of the present embodiment includes a data distribution unit 910, a reasoning unit 915, a renewing unit 920, a memory 925 and a processor 930.

The data distribution unit 910 distributes ontology data to respective nodes so as to perform the reasoning.

The data distribution unit 910 broadcasts the schema data of the ontology data after duplicating the schema data so that the schema data is stored in the memory of each of the nodes. Furthermore, the data distribution unit 910 partitions the triples other than the schema data and distributes the partitioned triples to the nodes. These are described above, and thus any further description concerning these will be omitted.

The reasoning unit 915 reasons the triple according to the reasoning order and the reasoning rule.

The renewing unit 920 renews the confidence value of the triple reasoned with duplication of the triples reasoned by the reasoning unit 915.

The renewing unit 920 may renew the confidence values of the triple reasoned with duplication through the maximum confidence value of the confidence values or calculation of the pMax.

These are described above, and thus any further description concerning these will be omitted.

The memory 925 stores various algorithms needed for performing the OWL Horst reasoning method based on the confidence value, data derived in the reasoning and so on.

The processor 930 controls the elements (for example, the data distribution unit 910, the reasoning unit 915, the renewing unit 920, etc.) of the ontology reasoning apparatus 900.

In FIG. 9, the ontology reasoning is performed by one ontology reasoning apparatus 900. However, a plurality of nodes may be used for performing the ontology reasoning. Each of the nodes includes the reasoning unit and the renewing unit in FIG. 9. In the event that the ontology reasoning is performed by the nodes, at least one of the nodes may perform a function of the master node, and the other nodes may perform the reasoning according to the reasoning rule, under control of the master node.

Components in the embodiments described above can be easily understood from the perspective of processes. That is, each component can also be understood as an individual process. Likewise, processes in the embodiments described above can be easily understood from the perspective of components.

Also, the technical features described above can be implemented in the form of program instructions that may be performed using various computer means and can be recorded in a computer-readable medium. Such a computer-readable medium can include program instructions, data files, data structures, etc., alone or in combination. The program instructions recorded on the medium can be designed and configured specifically for the present invention or can be a type of medium known to and used by the skilled person in the field of computer software. Examples of a computer-readable medium may include magnetic media such as hard disks, floppy disks, magnetic tapes, etc., optical media such as CD-ROM's, DVD's, etc., magneto-optical media such as floptical disks, etc., and hardware devices such as ROM, RAM, flash memory, etc. Examples of the program of instructions may include not only machine language codes produced by a compiler but also high-level language codes that can be executed by a computer through the use of an interpreter, etc. The hardware mentioned above can be made to operate as one or more software modules that perform the actions of the embodiments of the invention, and vice versa.

The embodiments of the invention described above are disclosed only for illustrative purposes. A person having ordinary skill in the art would be able to make various modifications, alterations, and additions without departing from the spirit and scope of the invention, but it is to be appreciated that such modifications, alterations, and additions are encompassed by the scope of claims set forth below.

### DESCRIPTION OF REFERENCE NUMBERS

900: ontology reasoning apparatus
910: data distribution
915: reasoning unit
920: renewing unit
925: memory
930: processor

1. An ontology reasoning method comprising:
(a) broadcasting a schema triple to nodes;
(b) partitioning triples other than the schema triple and distributing the partitioned triples to the nodes; and
(c) reasoning at least one of the schema triple or the triples according to a reasoning rule and then renewing a confidence value of the reasoned triple.

2. The ontology reasoning method of claim 1, wherein in the steps of (a) and (b), only triple related to a reasoning rule to be used of the reasoning rule is selectively broadcasted and partitioned.

3. The ontology reasoning method of claim 1, wherein in the step of (a), a join operation is performed about the schema triple when the schema triple corresponds to a multiple join rule, and new schema triple obtained by the join operation is broadcasted to each of the nodes.

4. The ontology reasoning method of claim 1, wherein the triples other than the schema triple include an instance triple and a type triple,
and wherein in the step of (b), the instance triple and the type triple is again partitioned by using a hash partitioning when the reasoning rule corresponds to a multiple join rule, and an instance triple and an type triple for reasoning according to a specific multiple join rule are partitioned to the same node.

5. The ontology reasoning method of claim 1, wherein in the step of (b), a RDD set is generated except a property when the reasoning rule corresponds to a transitivity rule, a new reasoning rule is generated through a join operation, an instance triple and a type triple are partitioned based on the generated new reasoning rule by using a hash partitioning and the partitioned triples are distributed to each of the nodes.

6. The ontology reasoning method of claim 1, wherein in the step of (c), confidence values of a triple reasoned with duplication according to the same reasoning rule are renewed to maximum confidence value of the confidence values when the confidence values differ.

7. The ontology reasoning method of claim 1, wherein in the step of (c), confidence values of a triple reasoned with duplication according to different reasoning rules are renewed to a confidence value calculated through pMax about the reasoned triple when the confidence values differ.

8. The ontology reasoning method of claim 1, wherein the triple is stored in a property table,
and wherein every data entering into a relation with a subject of the triple through a specific property is stored in each of rows of the property table.

9. A recording medium readable by a computer recording a program code for performing the method according to any one of claim 1 to claim 8.

10. An ontology reasoning apparatus comprising:
a data distribution unit configured to broadcast a schema triple to nodes, partition triples other than the schema triple and distribute the partitioned triples to the nodes;
a reasoning unit configured to reason at least one of the schema triple or the triples according to a reasoning rule; and
a renewing unit configured to renew a confidence value of the reasoned triple.

11. The ontology reasoning apparatus of claim 10, wherein the renewing unit renews confidence values of a triple reasoned with duplication through a maximum confidence value of the confidence values or a pMax operation.
